(19) United States
(12) Patent Application Publication
(10) Pub. No.: US 2005/0040661 A1
(43) Pub. Date: Feb. 24, 2005

(54) Multifunctional holder

(76) Inventor: Shih-Hao Hsu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/647,847

(22) Filed: Aug. 22, 2003

(51) Int. Cl. B25J 1/04

(52) U.S. Cl. 294/19.1

(57) ABSTRACT

A holder includes a handle, an extension rod having a first end combined with a first end of the handle, a threaded rod mounted in the handle, a control unit mounted in the handle and movably mounted on the threaded rod. a guide seat mounted on a second end of the extension rod, and an elastic plate mounted on the guide seat and having two ends each extended through the guide seat into the handle and each mounted on the control unit to move therewith. Thus, the holder can be used to hold and clamp articles of different sizes and shapes, thereby enhancing the versatility of the holder.

### BACKGROUND OF THE INVENTION

1. Field of the Invention

The present invention relates to a holder, and more particularly to a multifunctional holder that can be used to hold articles, such as brushes, razors or the like, thereby facilitating the user holding and clamping the article.

2. Description of the Related Art

A conventional holder comprises an elongated rod, a clamp pivotally mounted on a first end of the elongated rod, and a trigger mounted on a second end of the elongated rod and connected to the clamp. Thus, the trigger can be pressed by the user to open and close the clamp so as to clamp an article located at a higher location.

However, the user has to press the trigger successively, so that the clamp can hold the article closely. If the force applied on the trigger is released unintentionally, the clamp is opened, so that the article easily detaches from the clamp and falls down.

### SUMMARY OF THE INVENTION

The primary objective of the present invention is to provide a holder that can be used to hold and clamp articles of different sizes and shapes, thereby enhancing the versatility of the holder.

Another objective of the present invention is to provide a holder, wherein the elastic plate can be moved and adjusted rapidly, so that the holder can be used to hold and clamp the article rapidly.

A further objective of the present invention is to provide a holder that can be operated easily and conveniently, thereby facilitating the user operating the holder.

A further objective of the present invention is to provide a holder that can be used to take and clamp an article at a higher location, thereby enhancing the versatility of the holder.

A further objective of the present invention is to provide a holder, wherein the angle of the clamping seat can be adjusted, thereby enhancing the versatility of the holder.

In accordance with the present invention, there is provided a holder, comprising:
a handle;
an extension rod having a first end combined with a first end of the handle to form an elongated rod;
a threaded rod mounted in the handle;
a control unit mounted in the handle and movably mounted on the threaded rod;
a guide seat mounted on a second end of the extension rod; and
an elastic plate mounted on the guide seat and having two ends each extended through the guide seat into the extension rod and the handle and each mounted on the control unit to move therewith.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a holder in accordance with the preferred embodiment of the present invention;

FIG. 2 is a plan cross-sectional assembly view of the holder as shown in FIG. 1;

FIG. 3 is a partially cut-away plan cross-sectional assembly view of the holder as shown in FIG. 1;

FIG. 4 is a schematic operational view of the holder as shown in FIG. 3 in use;

FIG. 5 is a side plan cross-sectional view of a clamping seat of the holder as shown in FIG. 1;

FIG. 6 is a schematic operational view of the clamping seat of the holder as shown in FIG. 3 in use;

FIG. 7 is a schematic perspective assembly view of the holder as shown in FIG. 1 in use;

FIG. 8 is a schematic perspective assembly view of the holder as shown in FIG. 1 in use;

FIG. 9 is a schematic perspective assembly view of the holder as shown in FIG. 1 in use; and

FIG. 10 is a schematic perspective assembly view of the holder as shown in FIG. 1 in use.

### DETAILED DESCRIPTION OF THE INVENTION

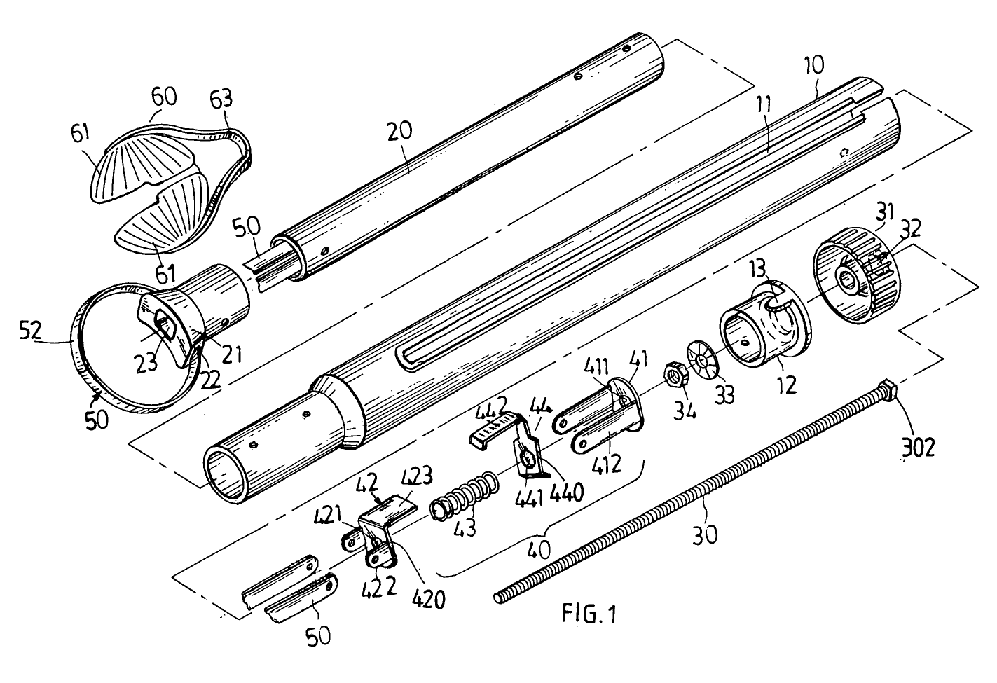

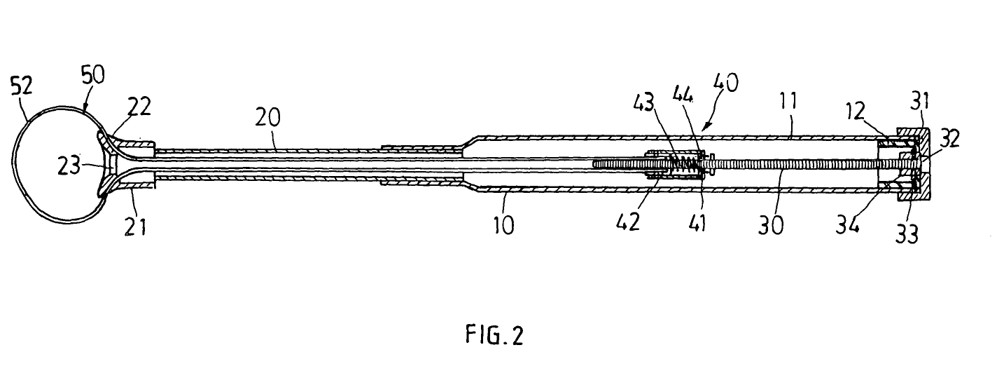

Referring to the drawings and initially to FIGS. 1-3, a holder in accordance with the preferred embodiment of the present invention comprises a handle 10, an extension rod 20 having a first end combined with a first end of the handle 10 to form an elongated rod, a threaded rod 30 mounted in the handle 10, a control unit 40 mounted in the handle 10 and movably mounted on the threaded rod 30, a guide seat 21 mounted on a second end of the extension rod 20, and an elastic plate 50 mounted on the guide seat 21 and having two ends each extended through the guide seat 21 into the extension rod 20 and the handle 10 and each mounted on the control unit 40 to move therewith.

The handle 10 is formed with an elongated slideway 11. The holder further comprises a sealing sleeve 12 mounted on a second end of the handle 10 and having a periphery provided with a retaining block 13 secured in the slideway 11 of the handle 10, so that the sealing sleeve 12 is secured on the handle 10 without rotation.

The holder further comprises an adjusting knob 31 rotatably mounted on the sealing sleeve 12 and secured on a distal end of the threaded rod 30 to rotate the threaded rod 30. The adjusting knob 31 has a side formed with a hexagonal recess 32, and the distal end of the threaded rod 30 is extended through the sealing sleeve 12 and is formed with a hexagonal head 302 secured in the hexagonal recess 32 of the adjusting knob 31.

The holder further comprises a washer 33 mounted on the threaded rod 30 and rested on the adjusting knob 31, and a nut 34 screwed on the threaded rod 30 and rested on the washer 33, so that the adjusting knob 31 is fixed on the distal end of the threaded rod 30.

The control unit 40 includes a base 41 movably mounted on the threaded rod 30 and combined with the two ends of the elastic plate 50, a connecting seat 42 movably mounted on the threaded rod 30 and combined with the two ends of the elastic plate 50, a control plate 44 pivotally mounted on the threaded rod 30 and located between the base 41 and the connecting seat 42, and a spring 43 mounted on the threaded rod 30 and urged between the connecting seat 42 and the control plate 44.

The base 41 is formed with a through hole 411 for passage of the threaded rod 30 and is provided with two spaced pivot plates 412 fixed on the two ends of the elastic plate 50.

The connecting seat 42 is substantially L-shaped and has a first section 420 movably mounted on the threaded rod 30 and a second section 423 to encompass the spring 43. The first section 420 of the connecting seat 42 is formed with a through hole 421 for passage of the threaded rod 30 and is provided with two spaced pivot plates 422 fixed on the two ends of the elastic plate 50.

The control plate 44 is substantially L-shaped and has a first section 440 pivotally on the threaded rod 30 and a second section formed with a press portion 442 protruding outward from the slideway 11 of the handle 10. The first section 440 of the control plate 44 is pressed by the spring 43 and is formed with a through hole 441 for passage of the threaded rod 30.

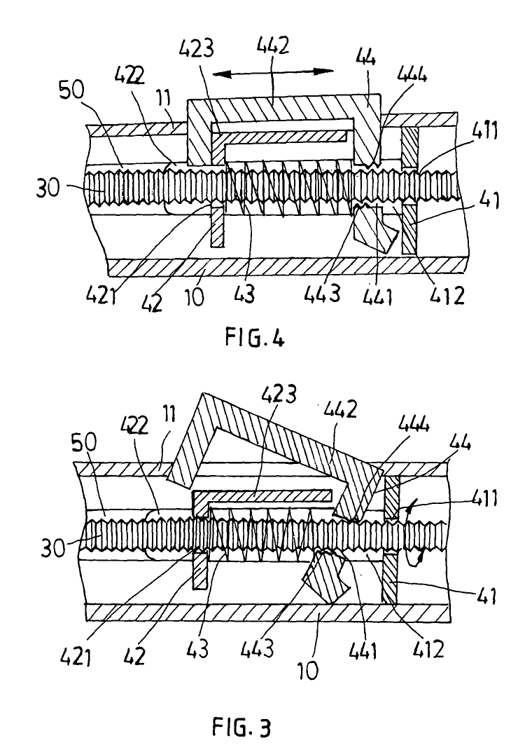

As shown in FIG. 3, the through hole 441 of the control plate 44 has a first edge formed with a first thread 443 and a second edge formed with a second thread 44 which is diagonally opposite to the first thread 443.

Thus, when the first section 440 of the control plate 44 is pressed by the spring 43 to an inclined state as shown in FIG. 3, the first thread 443 and the second thread 44 of the through hole 441 of the control plate 44 are engaged with the threaded rod 30, so that the control plate 44 is fixed on the threaded rod 30, and when the press portion 442 of the control plate 44 is pressed by the user to a horizontal state as shown in FIG. 4, the first section 440 of the control plate 44 is disposed at a vertical state, so that the first thread 443 and the second thread 44 of the through hole 441 of the control plate 44 are detached from the threaded rod 30, and the control plate 44 is movable on the threaded rod 30.

The elastic plate 50 has a mediate portion formed with a circle 52 protruded outward from the guide seat 21, and the guide seat 21 has two sides each formed with a guide channel 22 for passage of each of the two ends of the elastic plate 50.

The holder further comprises a clamping seat 60 mounted on the guide seat 21 and received in the circle 52 of the elastic plate 50. The guide seat 21 is formed with a recess 23. The clamping seat 60 includes a substantially V-shaped clamping plate 63 inserted into the recess 23 of the guide seat 21 and two substantially semi-spherical clamping jaws 61 each pivotally mounted on the clamping plate 63.

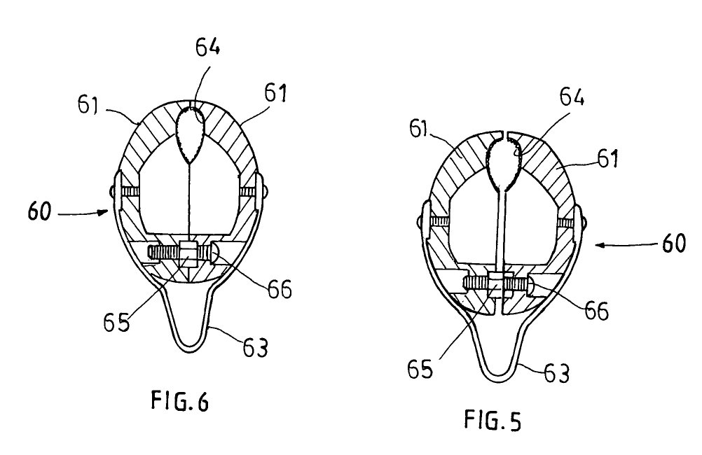

As shown in FIG. 5, the clamping seat 60 further includes a bolt 66 extended through the two clamping jaws 61, and a nut 65 secured in an end of one of the two clamping jaws 61 and screwed on the bolt 66. Thus, the bolt 66 can be rotated to adjust the distance between the two clamping jaws 61 as shown in FIGS. 5 and 6.

In operation, when the first section 440 of the control plate 44 is pressed by the spring 43 to an inclined state as shown in FIG. 3, the first thread 443 and the second thread 44 of the through hole 441 of the control plate 44 are engaged with the threaded rod 30, so that the control plate 44 is fixed on the threaded rod 30. When the press portion 442 of the control plate 44 is pressed by the user to a horizontal state as shown in FIG. 4, the first section 440 of the control plate 44 is disposed at a vertical state, so that the first thread 443 and the second thread 44 of the through hole 441 of the control plate 44 are detached from the threaded rod 30, and the control plate 44 is movable on the threaded rod 30.

In such a manner, the article can be placed into the circle 52 of the elastic plate 50. Then, the control plate 44 is pushed to move relative to the threaded rod 30 in the slideway 11 of the handle 10 to move the two ends of the elastic plate 50 in the handle 10, thereby contracting the circle 52 of the elastic plate 50, so that the article is clamped by the circle 52 of the elastic plate 50. Then, the force applied on the press portion 442 of the control plate 44 is removed, so that the first section 440 of the control plate 44 is pressed by the spring 43 to the inclined state as shown in FIG. 3, and the first thread 443 and the second thread 44 of the through hole 441 of the control plate 44 are engaged with the threaded rod 30. Thus, the control plate 44 is fixed on the threaded rod 30. Then, the threaded rod 30 can be rotated by the adjusting knob 31. At this time, the first thread 443 and the second thread 44 of the through hole 441 of the control plate 44 are engaged with the threaded rod 30, so that the control plate 44 is moved by rotation of the threaded rod 30 so as to move the two ends of the elastic plate 50 in the handle 10, thereby slightly contracting the circle 52 of the elastic plate 50, so that the article is clamped by the circle 52 of the elastic plate 50 closely.

Accordingly, when the press portion 442 of the control plate 44 is disposed at the horizontal state as shown in FIG. 4, the elastic plate 50 is moved largely and macro-adjusted so as to clamp the article in a loose manner, and when the first section 440 of the control plate 44 is disposed at the inclined state as shown in FIG. 3, the elastic plate 50 is moved slightly and micro-adjusted so as to clamp the article in a close manner.

Alternatively, the clamping plate 63 of the clamping seat 60 is inserted into the recess 23 of the guide seat 21, so that the two clamping jaws 61 of the clamping seat 60 are received in the circle 52 of the elastic plate 50 to clamp a smaller article.

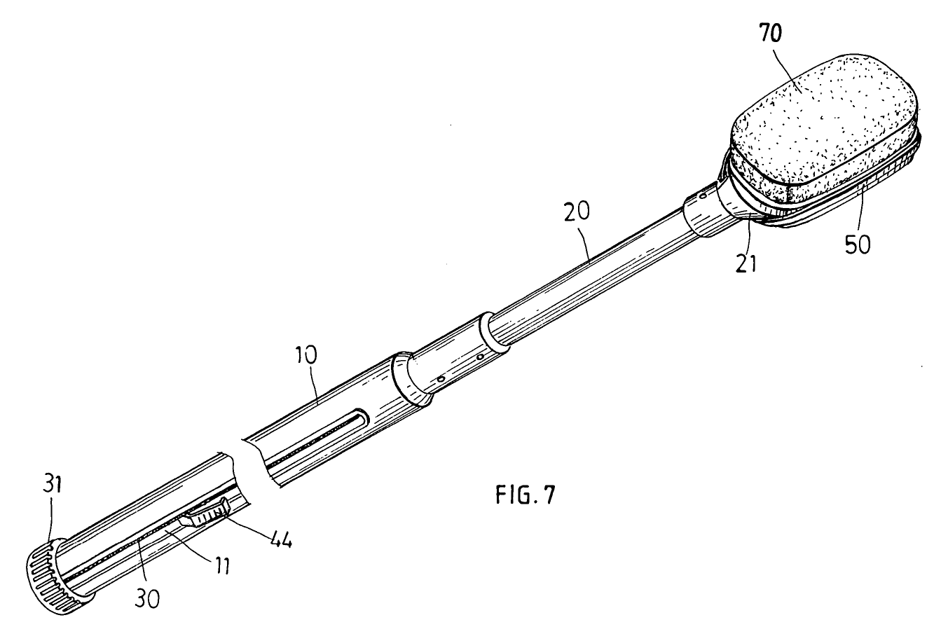

As shown in FIG. 7, the elastic plate 50 is used to clamp a sponge brush 70.

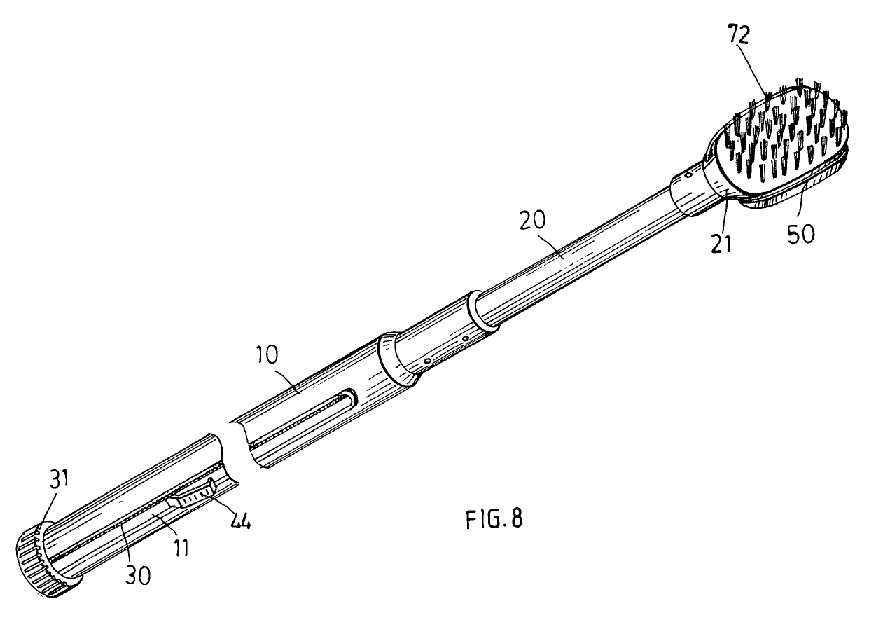

As shown in FIG. 8, the elastic plate 50 is used to clamp a brush 72.

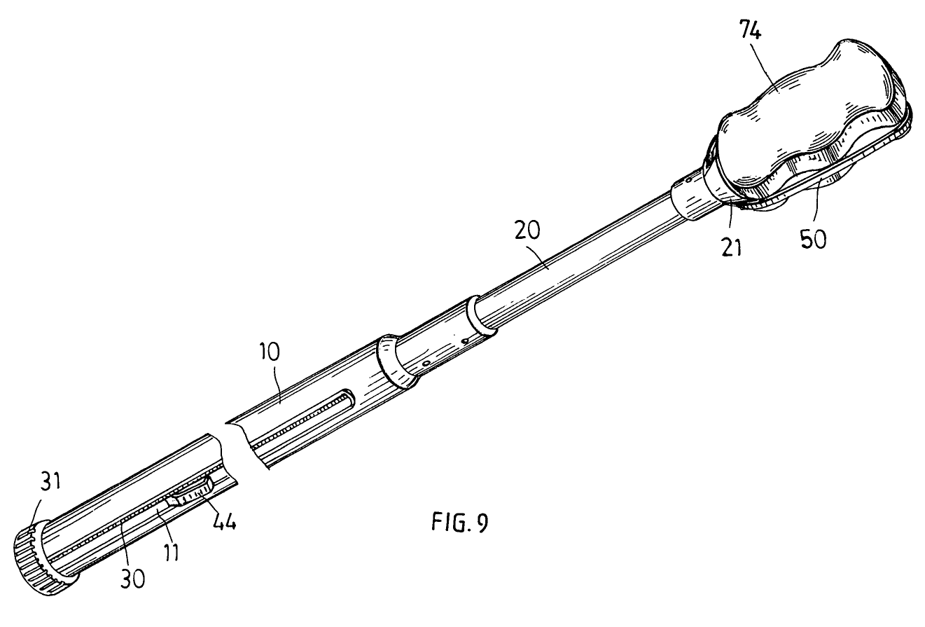

As shown in FIG. 9, the elastic plate 50 is used to clamp a molded brush 74.

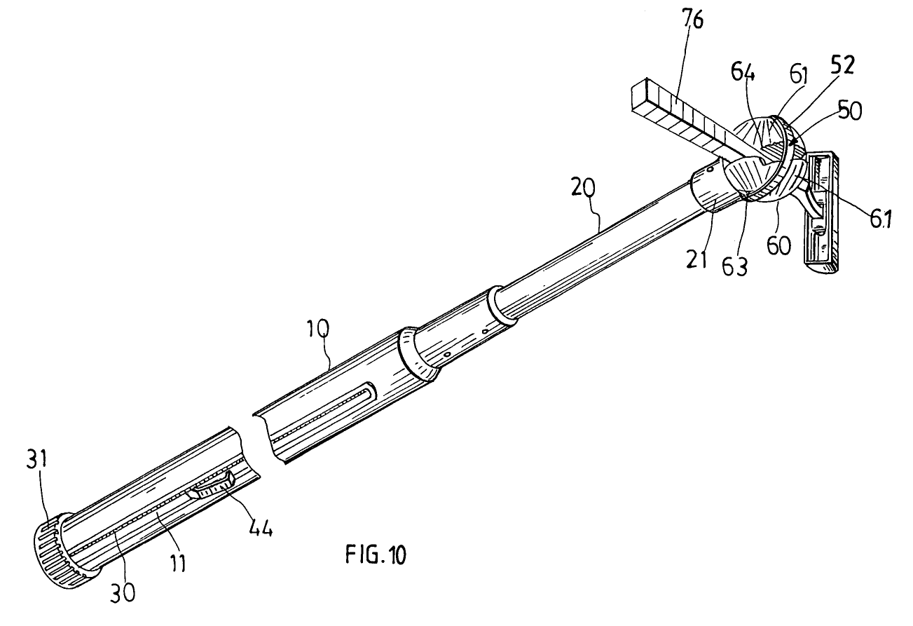

As shown in FIG. 10, the elastic plate 50 co-operates with the clamping seat 60 to clamp a razor 76.

Accordingly, the holder can be used to hold and clamp articles of different sizes and shapes, thereby enhancing the versatility of the holder. In addition, the elastic plate 50 can be moved and adjusted rapidly, so that the holder can be used to hold and clamp the article rapidly. Further, the holder can be operated easily and conveniently, thereby facilitating the user operating the holder. Further, the holder can be used to take and clamp an article at a higher location, thereby enhancing the versatility of the holder. Further, the angle of the clamping seat 60 can be adjusted, thereby enhancing the versatility of the holder.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A holder, comprising:
a handle;
an extension rod having a first end combined with a first end of the handle to form an elongated rod;
a threaded rod mounted in the handle;
a control unit mounted in the handle and movably mounted on the threaded rod;
a guide seat mounted on a second end of the extension rod; and
an elastic plate mounted on the guide seat and having two ends each extended through the guide seat into the extension rod and the handle and each mounted on the control unit to move therewith.

2. The holder in accordance with claim 1, wherein the control unit includes a base movably mounted on the threaded rod and combined with the two ends of the elastic plate, a connecting seat movably mounted on the threaded rod and combined with the two ends of the elastic plate, a control plate pivotally mounted on the threaded rod and located between the base and the connecting seat, and a spring mounted on the threaded rod and urged between the connecting seat and the control plate.

3. The holder in accordance with claim 2, wherein the base is formed with a through hole for passage of the threaded rod.

4. The holder in accordance with claim 2, wherein the base is provided with two spaced pivot plates fixed on the two ends of the elastic plate.

5. The holder in accordance with claim 2, wherein the connecting seat is substantially L-shaped and has a first section movably mounted on the threaded rod and a second section to encompass the spring.

6. The holder in accordance with claim 5, wherein the first section of the connecting seat is formed with a through hole for passage of the threaded rod.

7. The holder in accordance with claim 5, wherein the first section of the connecting seat is provided with two spaced pivot plates fixed on the two ends of the elastic plate.

8. The holder in accordance with claim 2, wherein the control plate is substantially L-shaped and has a first section pivotally on the threaded rod and a second section formed with a press portion protruding outward from a slideway of the handle.

9. The holder in accordance with claim 8, wherein the first section of the control plate is pressed by the spring and is formed with a through hole for passage of the threaded rod.

10. The holder in accordance with claim 9, wherein the through hole of the control plate has a first edge formed with a first thread and a second edge formed with a second thread which is diagonally opposite to the first thread.

11. The holder in accordance with claim 10, wherein the when the first section of the control plate is pressed by the spring to an inclined state, the first thread and the second thread of the through hole of the control plate are engaged with the threaded rod, so that the control plate is fixed on the threaded rod.

12. The holder in accordance with claim 10, wherein the when the press portion of the control plate is pressed by the user to a horizontal state, the first section of the control plate is disposed at a vertical state, so that the first thread and the second thread of the through hole of the control plate are detached from the threaded rod, and the control plate is movable on the threaded rod.

13. The holder in accordance with claim 1, wherein the handle is formed with an elongated slideway, and the holder further comprises a sealing sleeve mounted on a second end of the handle and has a periphery provided with a retaining block secured in the slideway of the handle, so that the sealing sleeve is secured on the handle without rotation.

14. The holder in accordance with claim 13, further comprising an adjusting knob rotatably mounted on the sealing sleeve and secured on a distal end of the threaded rod to rotate the threaded rod.

15. The holder in accordance with claim 14, wherein the adjusting knob has a side formed with a hexagonal recess, and the distal end of the threaded rod is extended through the sealing sleeve and is formed with a hexagonal head secured in the hexagonal recess of the adjusting knob.

16. The holder in accordance with claim 14, further comprising a washer mounted on the threaded rod and rested on the adjusting knob, and a nut screwed on the threaded rod and rested on the washer, so that the adjusting knob is fixed on the distal end of the threaded rod.

17. The holder in accordance with claim 1, wherein the elastic plate has a mediate portion formed with a circle protruded outward from the guide seat, and the guide seat has two sides each formed with a guide channel for passage of each of the two ends of the elastic plate.

18. The holder in accordance with claim 17, further comprising a clamping seat mounted on the guide seat and received in the circle of the elastic plate.

19. The holder in accordance with claim 18, wherein the guide seat 21 is formed with a recess, and the clamping seat includes a substantially V-shaped clamping plate inserted into the recess of the guide seat and two substantially semi-spherical clamping jaws each pivotally mounted on the clamping plate.

20. The holder in accordance with claim 18, wherein the clamping seat further includes a bolt extended through the two clamping jaws, and a nut secured in an end of one of the two clamping jaws and screwed on the bolt, so that the bolt can be rotated to adjust the distance between the two clamping jaws.
